(19) United States
(12) Patent Application Publication
(10) Pub. No.: US 2009/0188856 A1
(43) Pub. Date: Jul. 30, 2009

(54) Externally Centering Filter Element or Cartridge and Housing and System Utilizing the Same

(76) Inventors: Robb Benson, Montgomery, TX (US); John H. Burban, Lake Elmo, MN (US); Mohammad I. Farooq, Spring, TX (US); Paul D. Osmundson, Ames, IA (US); Mathews J. Thundyil, The Woodlands, TX (US)

Correspondence Address: MARSHALL & MELHORN, LLC;Attention: D. Edward Dolgorukov, Esq., Four Seagate - 8th Floor, Toledo, OH, 43604, US

(21) Appl. No.: 12/400,889

(22) Filed: Mar. 10, 2009

Related U.S. Application Data
(63) Continuation-in-part of application No. 12/234,965, filed on Sep. 22, 2008.
(60) Provisional application No. 60/981,488, filed on Oct. 20, 2007.

(51) Int. Cl. B01D 29/50; B01D 35/30

(52) U.S. Cl. 210/323.2; 210/442

(57) ABSTRACT

A filter assembly for filtering contaminants from any fluid stream. The housing of the filter assembly is preferably made of any metal and/or polymer, and can hold one or two externally centering filter elements or cartridges, each of which can hold a single filter, or multiple filters. Flow in filter housings having two externally centering filter elements or cartridges can be unidirectional or opposed.

### RELATED APPLICATION

This application is a continuation-in-part of application Ser. No. 12/234,965, filed on Sep. 22, 2008, for Method and Apparatus for the Purification of Salty Streams. Application Ser. No. 12/234,965 claims the benefit, under 35 U.S.C. §119(e), of the provisional application filed Oct. 20, 2007 under 35 U.S.C. §111(b), which was granted Ser. No. 60/981,488. This provisional application is hereby incorporated by reference in its entirety. Application Ser. No. 12/234,965 is pending as of the filing date of the present application.

### FIELD OF THE INVENTION

The present invention relates generally to the purification of any fluid streams. More particularly, the invention relates to an apparatus used for the removal of particulate contamination from the referenced stream. Most particularly, the invention relates to an externally centering filter element or cartridge and housing system utilizing the same.

### BACKGROUND OF THE INVENTION

There are many filter elements or cartridges, and associated housings available for the purification or filtration of fluid streams. However, they are usually of limited versatility because they utilize a centering rod or end cap(s), and have the limitation that the flow through the housing is designed to be in one direction.

### SUMMARY OF THE INVENTION

In order to solve the above-mentioned problems in the prior art, the present invention, in one of its embodiments, provides for a housing which can be made of any metal and/or any polymer, wherein externally centering elements for particulate removal or adsorptive removal can be placed within. In another of its embodiments, it provides for such a housing where the elements can be installed from both ends of the housing. The inlets are close to the two ends, with the outlet in the center. Because elements can be installed in this housing from both ends, this system can have twice the flow capability of the conventional “unidirectional” housing. The bidirectional flow is a novelty in the industry. The use of such housings for adsorptive purification is a novelty in the industry.

Nozzles (inlets or outlets) can be on the shell of the vessel, or on the closures, although it is preferred to have them on the shell of the vessel.

In the case of inside-to-out flow known to the market, the tubesheet assembly can be retained without glue, through the use of a sealing elastomer and a retaining spiral ring. This allows for the tubesheet and cage to be repaired if needed.

The invention can also be used for outside-to-inside flowing elements. In this configuration, the tubesheet is set further back in the housing, but is still retained in place by means of the same seal and retaining spiral ring.

The outside to inside filter elements needs to have an internal core that resists differential pressure. This core can be inherent to the filter element, or attached to the vessel itself.

Outside to inside flowing filter elements generally need to have a guide mechanism, particularly in a horizontal configuration, to facilitate installation on a sealing surface. This is usually accomplished by a guide post of some kind. Since the guide post can accumulate contaminant during change-out, this is not desired. Consequently, we have proposed an external guide mechanism for these elements. For single element housings, this mechanism involves tabs on the element that self center against the ID of the vessel. For multi-element housings, these tabs may ride on external guide assemblies and the ID of the vessel wall.

The centering mechanism may be a tongue-and-groove arrangement, with either the tongue or groove a part of the element. It is preferred to have the groove part of the element, to prevent accumulation of contaminant within the groove during change-out.

The inside to outside flowing element comprises a retaining member or cage that is either inherent to the element, or extrinsic to it within the housing.

The elements to be used within these housings may include conventional fibrous porous media in a pleated or blown configuration, adsorbent canisters, cartridges, or blocks comprised of such materials as carbon. The elements may be configured in the form of a single element with two end-caps, or as an element jointed together with multiple joint pieces. The elements may be generally cylindrical, although there may be advantages to having them tapered for certain kinds of flow configurations. For an inside to out flowing element seated within a retaining cage, a taper can be advantageous in the retrieval of the element out of the housing.

If the element is comprised of pleated media, there is a need to maintain pleat spacing to allow maximal contaminant loading within the external surface of the pleats. This is generally done by depositing epoxy in circular, or helical bands around the element, or by the use of a wrap of media that is bonded to the pleats. If the element flows in-to-out, there is a need to protect the media from billowing out.

We are proposing a novel way of addressing either concern, through the use of pre-impregnated tows or fiber wraps that are bonded to the tips of the pleat. The bonding mechanism may involve heat, or a curing agent. It is preferred, but not necessary, that the tows or fiber wraps be helically wound around the element and sufficiently spaced to bond to the tips of the pleats, and thus, keep the pleats fixed. The pre-impregnated tows or fiber wraps may be thermoset or thermoplastic impregnated. The advantage of this is that the media is not lost, or hidden to flow by the bonding mechanism, and is accomplished at a lower cost than by the use of epoxy or adhesive being dripped into the spaces between the pleats.

The pre-impregnated tows or fiber wraps may be wrapped multiple times over each other at each of the endcaps to prevent unwinding or they may be fixed in the endcap.

Housings for these purposes have usually had closures that are fully detachable from the vessel because the vessels rarely need to be accessed on an ongoing basis, since they are used primarily for membrane enclosures. If they are to be used for particle filtration, they may have to be accessed every week to every month, rather than on a yearly type basis with membranes. This invention provides for a closure that is attached to the vessel that can be swung out of the way, without having to be completely detached from the vessel.

Vertical or horizontal installations are acceptable, although horizontal is preferred.

### BRIEF DESCRIPTION OF THE DRAWINGS

The following is a brief description of the drawings, wherein like parts have like numbers in the various views.

FIG. 1 is a perspective view of a construction embodying the present invention.

FIG. 2 is an elevational view, partly cut away, of the construction shown in FIG. 1.

FIG. 3 is a left hand end view, partially broken away, of the construction shown in FIG. 1.

FIG. 4 is an exploded perspective view of the construction shown in FIG. 1.

FIG. 5 is a sectional view, taken in the direction of the arrows, along the section line 5-5 of FIG. 2.

FIG. 5A is similar in large part to FIG. 5, but showing the use of a tapered element in the housing shown in FIG. 5.

FIG. 5B shows the use of a tapered element similar to that shown in FIG. 5A in a tapered housing.

FIG. 6 is an elevational sectional view of a construction embodying a modification of the present invention.

FIG. 7 is an exploded perspective view, partly in section, of the construction shown in FIG. 6.

FIG. 8 is an elevational view of a construction embodying a further modification of the present invention.

FIG. 9 is a sectional view, taken in the direction of the arrows, along the section line 9-9 of FIG. 8.

FIG. 10 is an exploded perspective view, partially broken away, of a still further modification of the present invention.

FIG. 11 is a sectional view, taken in the direction of the arrows, along the section line 11-11 of FIG. 9.

FIG. 12 is diagrammatic view illustrating how a multiple filter element is supported inside a filter housing.

FIG. 13 is an elevational sectional view of a construction embodying a still further modification of the present invention.

FIG. 14 is an exploded perspective view, partially cut away, of the construction shown in FIG. 13.

FIG. 15 is a perspective view of a filter frame used in the present invention.

FIG. 16 is an end in view of a modification of the construction shown in FIG. 15.

FIG. 17 is an end view of a further modification of the construction shown in FIG. 15.

FIG. 18 is an end in view of yet another modification of the construction shown In FIG. 15.

FIG. 19 is a perspective view of a filter showing how a preimpregnated tow or fiber wrap may be helically wound around the pleats of the filter to maintain the pleat spacing.

FIG. 20 is a sectional view, taken in the direction of the arrows, along the section line 20-20 of FIG. 19.

FIG. 21 is an elevational sectional view, similar in part to FIG. 5, but showing in to out flow and the use of a filtration element or cartridge having an internal core for support.

FIG. 22 is a partial perspective view of the construction shown in FIG. 21.

FIG. 23 is partial perspective view of a construction embodying the present invention showing how a closure member may be mounted to a davit so that the closure member may be easily swung out of the way when it is desired to change a filtration element or cartridge.

FIG. 24 is a perspective view showing a still further modification of the invention.

FIG. 25 is a sectional view, taken in the direction of the arrows, along the section line 25-25 of FIG. 24.

FIG. 26 is a perspective view, similar in part to FIG. 1, but showing yet a further modification of the present invention.

FIG. 27 is a sectional view, taken in the direction of the arrows, along the section line 27-27 of FIG. 26.

### DESCRIPTION OF THE PREFERRED EMBODIMENTS

For purposes of the description to follow the following terms shall have the following meanings.

A “twin filter assembly” is a filter assembly comprising two externally centering filtration elements or cartridges in a metal and/or or polymer housing.

A “single filter assembly” is a filter housing comprising one externally centering filtration element or cartridge in a metal and/or polymer housing.

Each “externally centering filtration element or cartridge” may contain a single filter and be referred to as a “single filter element or cartridge”, or it may contain at least two, preferably three, filters and be referred to as a “multiple filter element or cartridge”.

A “filter” may comprise, but is not limited to, a pleated filter, melt-blown, spun-bonded, or formed porous media constructed by means known to those skilled in the art. The media may comprise fibers, or particles. Examples would be a filter comprised of polypropylene fibrous media, inorganic fibrous media, a porous block, cartridge or canister of carbon or other adsorbent material.

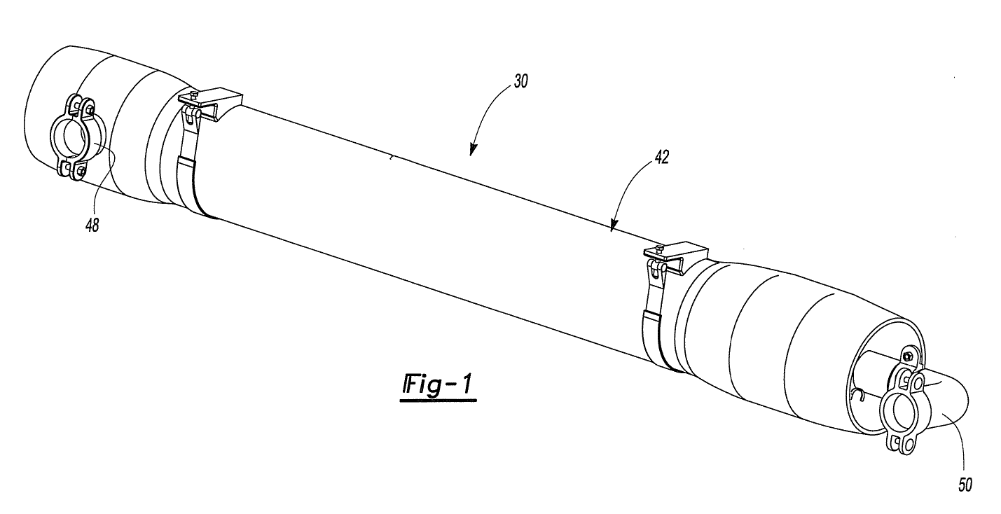

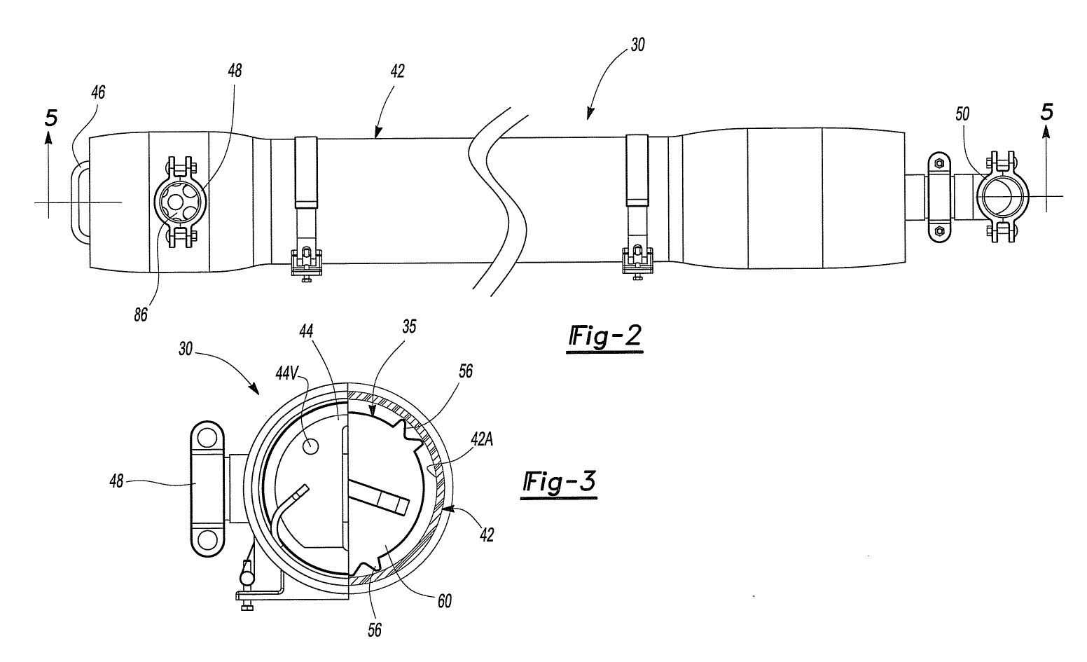

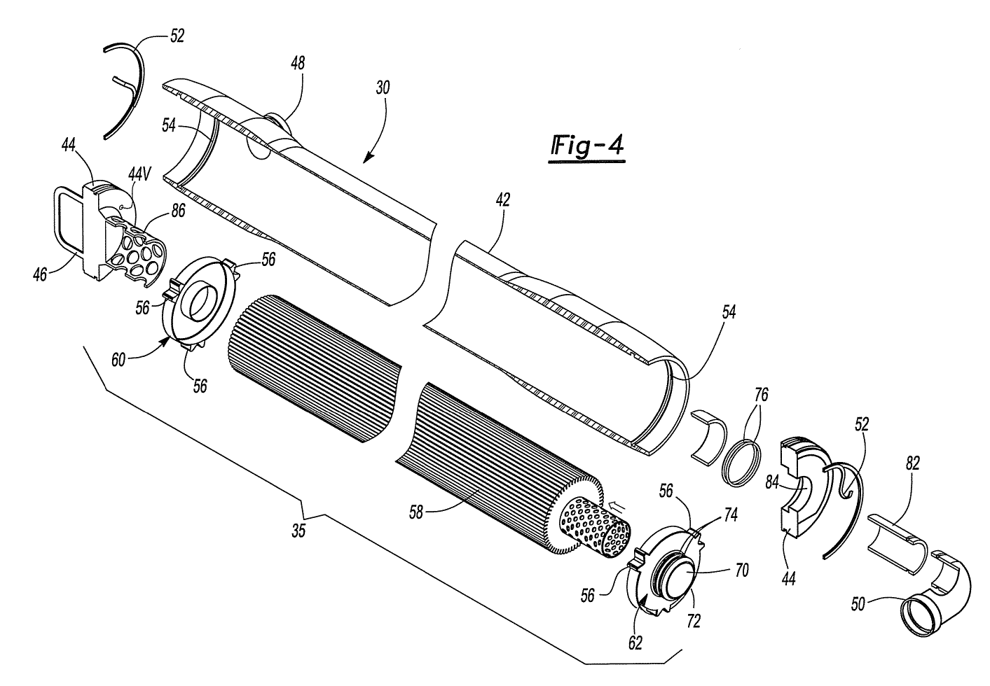

Referring to FIGS. 1-5, there is illustrated a single filter assembly generally designated by the numeral 30. The single filter assembly 30 comprises a single filter element or cartridge, generally designated by the numeral 35.

The single filter assembly 30 comprises an axially extending, hollow, generally tubular shaped, single element housing, generally designated by the numeral 42, which is closed at its inlet end by an inlet closure member 44, and at its outlet end by an outlet closure member 45.

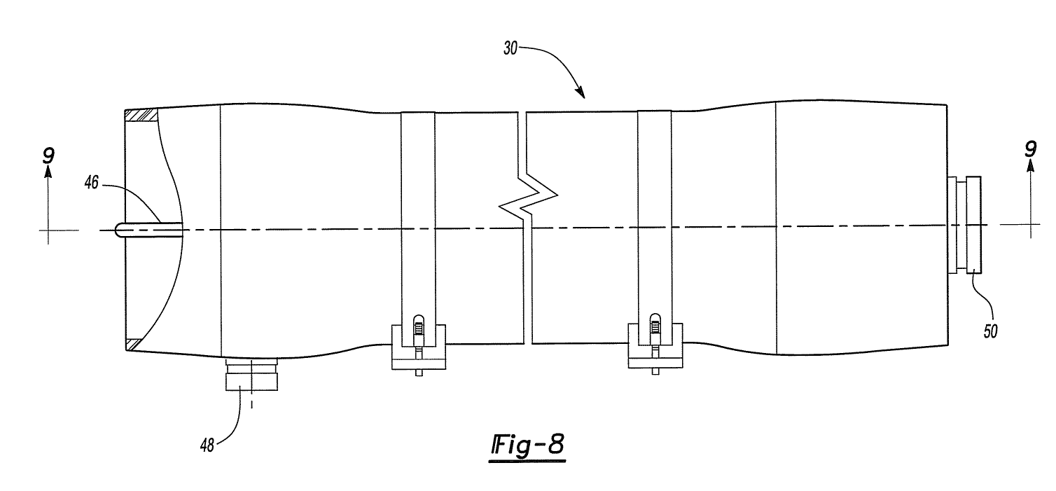

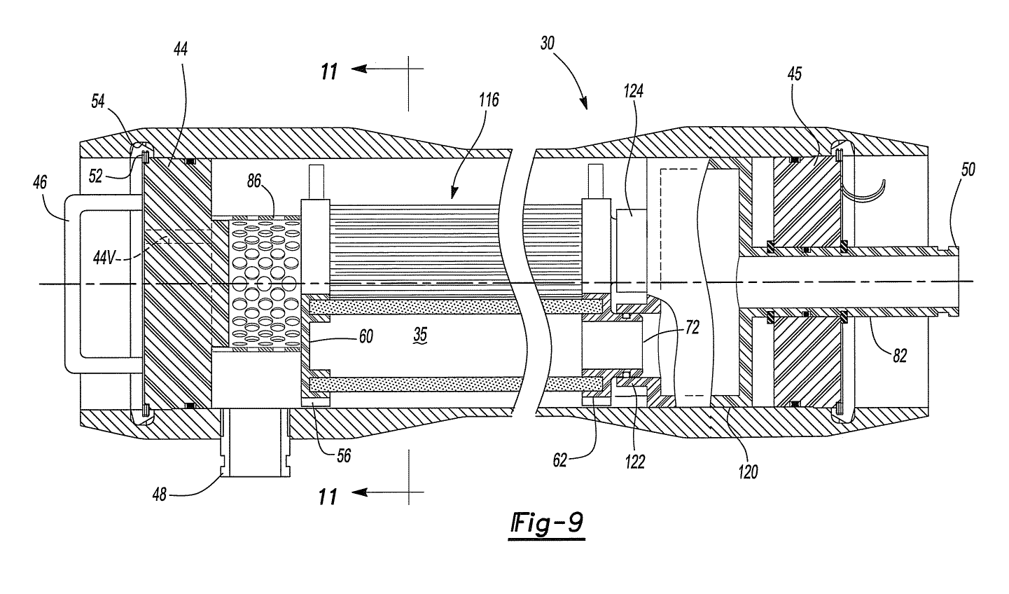

In order to provide for removal of any air or other gas present during startup, a vent 44V is provided in either the inlet closure member 44, or the outlet closure member 45. The vent 44V is shown in the inlet closure member in FIGS. 3, 4, 5, 5A, 6, 7, 9, 10, 13 and 21. The vent 44V will be provided with a suitable valve mechanism(s) and a suitable control means, all of which are well known in the art, to close the vent after startup. It is also well within the scope of the art to place the vent 44V in the wall of the housing (42, 92) if desired.

Each closure member (44, 45) may have one or more handles 46 to aid in removing the closure member. Retaining spiral rings 52, which fit in retaining grooves 54, hold the closure members (44, 45) in place during operation, and are removable when it is desired to change the single filter element or cartridge 35.

The single element housing 42 will have at least one single element inlet 48, and at least one single element outlet 50 for the out-to-in version of the invention illustrated. It is well within the scope of the present invention that the number of inlets 48 and outlets 50 may vary depending on the application, as well as the positioning thereof. Also, since the invention may also be used for in-to-out flow, the inlets 48 may function as outlets, and the outlets 50 may function as inlets.

Referring to FIGS. 3-5, the single filter element or cartridge 35 includes a cylindrical, preferably pleated, porous media 58 to which is affixed by means known in the art an inlet end cap 60, and an outlet end cap 62. Inlet end cap 60 has a plurality of tabs 56 equally spaced about its periphery, and has a solid end wall 64 to block any flow therethrough. An inner, upstanding, retaining wall 66, and an outer upstanding, retaining wall 68 accept an end of the pleated porous media 58.

At the other end of the porous media is the outlet end cap 62. In the out to in flow version of the invention being illustrated, the fluid must enter the interior of the cylindrical, pleated, porous media through the pleats thereof, travel the length thereof, and exit out the other end. To facilitate this, the outlet end cap again has tabs 56 to center the endcap in the interior of the single element housing 42. Preferably, but not necessarily, the diameter of the inlet end cap 60, and the outlet end cap 62, are substantially equal.

Since the outlet end cap must permit flow therethrough, while inner retaining wall 66 and outer retaining wall 68 are present, instead of solid end wall 64, an aperture 70 is provided to permit flow through the outlet end cap 62,

Aperture 70 is in fluid communication with the outlet 72. One or more annular grooves 74 are provided therein to accept one or more O-rings 76 or other sealing means known in the art. This permits the outlet 72 of the outlet endcap 62 to sealingly engage the plenum inlet 78 of outlet plenum 80. The outlet tube 82 is in fluid communication with the interior of outlet plenum 80, and sealingly engages the outlet aperture 84 in the outlet closure member 45.

With the outlet closure member 45 held in place by retaining spiral ring 52, and the perforated spacer 86 provided on the inlet closure member 44, which is also held in place by a retaining spiral ring 52, providing pressure against the single filter element 35, a non-salty stream will enter inlet 48, proceed along the interior wall 42A of single element housing 42, be forced to flow through the pleats 58A of cylindrical pleated porous media 58, through the aperture 70 in the outlet end cap 62, through the outlet plenum 80 and out the outlet tube 82, thereby removing the particulates from the non-salty stream.

Depending on the application, it may be desirable to have a perforated, inner, support core 88, having a plurality of apertures 89, to prevent implosion of the porous media 58.

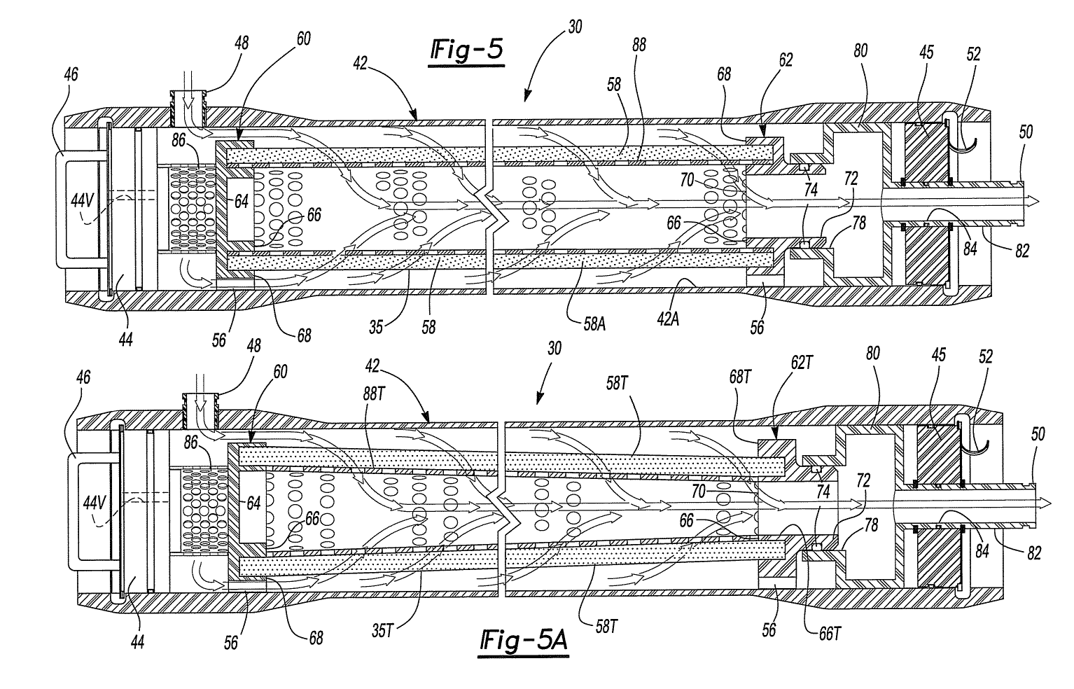

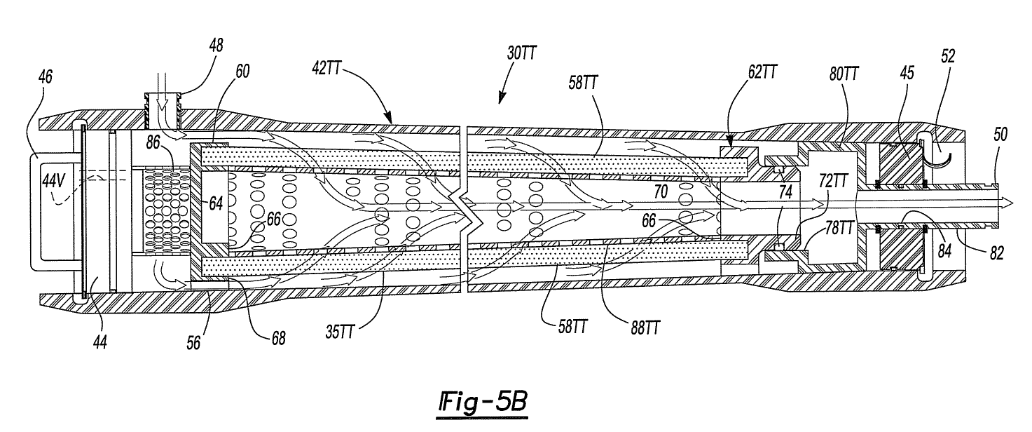

With reference to FIG. 5A, in some applications it may be desired to use a tapered filter element or cartridge in the housing shown in FIG. 5. While this requires no modification of the single element housing 42, the construction of the single filter element or cartridge is modified. For purposes of ease of understanding, the tapered single filter element or cartridge will now be identified by the numeral 35T.

The inlet endcap 60 of the tapered filter element or cartridge may be the same as used in the construction shown in FIG. 5, and is identified by the same numeral 60. However, the outlet endcap 62T is modified to have a thicker outer retainer wall 68T, and a thinner inner retainer wall 66T. This allows for the reception of the smaller diameter of the tapered inner core 88T and tapered media 58T without changing the sizes of the plenum inlet 78 or the outlet plenum 80.

Referring to FIG. 5B, in some applications it may be desireable to use a tapered single filter or element in a tapered housing. For ease of understanding, the differences in construction between FIGS. 5A and 5B will be highlighted. The suffix TT (tapered housing, tapered element) will be applied to the portions of the construction which are different.

Inlet end cap 60 remains the same as before, however, the diameter of outlet endcap 62TT is smaller, as is the diameter of outlet plenum 80TT to permit the diameter of the tapered single element housing 42TT to be smaller. The diameter of the tapered filter media 58TT, and the perforated inner support core 58TT will change accordingly. The diameter of the plenum inlet 78TT and the circular outlet 72TT may also change.

While FIGS. 5, 5A and 5B have been described by referring to each other, it is well within the scope of the present invention that the devices described may vary from each other and be of any desired dimension and configuration.

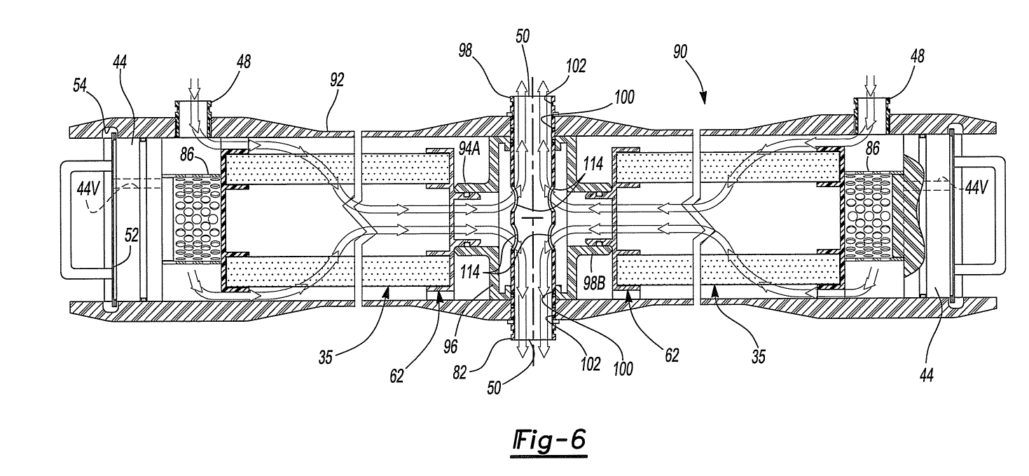

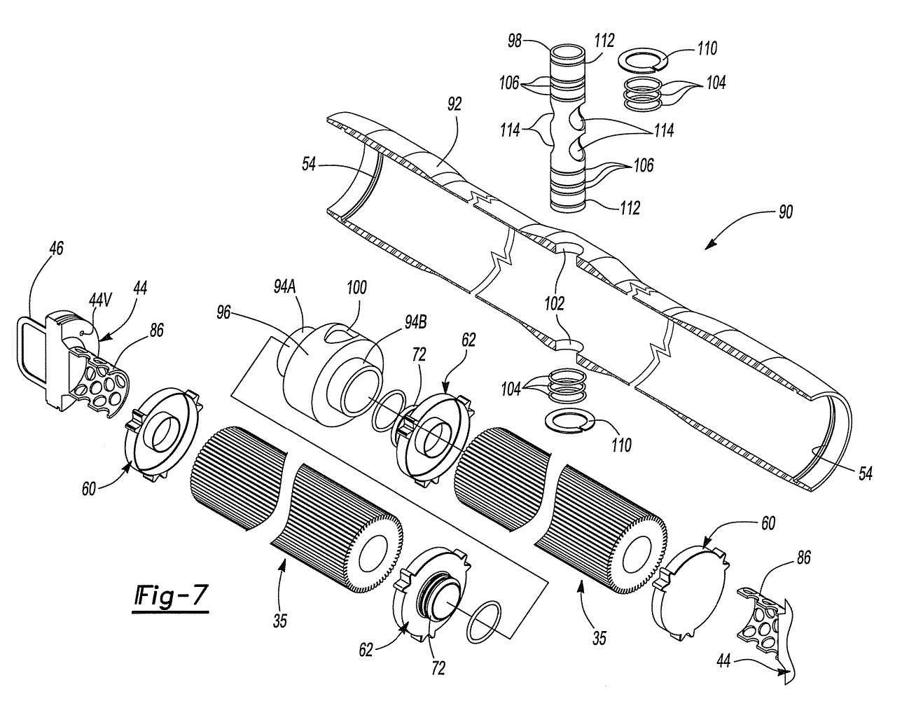

Referring now to FIGS. 6-7, there is shown a twin filter assembly, generally designated by the numeral 90, comprising a twin element housing 92 having two single filtration elements or cartridges 35 therein. The flow is illustrated as being from out-to-in, although it is well within the scope of the present invention to have the flow be from in-to-out.

The construction of the single filter elements or cartridges 35 may be identical to that described hereinabove. A pair of inlets 48 are provided, one at each end of the twin element housing 92. A pair of inlet closure members 44 hold the filter elements 35 in place. They, in turn, are held in place by a pair of retainer springs 52 which fit in a like pair of retaining grooves 54.

In this modification of the invention, the outlet closure member 45 is not needed. The two single filtration elements or cartridges are placed into the twin element housing 92 in a 180° opposed relationship. In other words, the outlet endcaps 62 are facing each other. Each of the outlet endcaps 62 has its respective outlet 72 in sealing fluid communication with one of the inlets (94A,94B) of the twin element outlet plenum 96, which is interposed between the two single filter elements or cartridges 35 in the twin element housing 92.

The outlet plenum 96 has a pair of vertically axially aligned plenum apertures 100, which are placed in alignment with a pair of housing apertures 102, and then the outlet tube 98 is passed through the apertures (102, 100, 100, 102) to fix the twin element outlet plenum 96 in place. Suitable O-rings 104 which fit into outlet tube O-ring grooves 106 seal the outlet tube 98 in place, while a pair of lock rings 110, which are retained in ring grooves 112, secure the outlet tube 98 in place. This construction provides a pair of outlets 50 for the fluid stream.

In operation, a fluid stream which is to have particulates removed therefrom is introduced into each inlet 48. This will cause flow through the apparatus to be in opposing directions as indicated by the flow arrows. The fluid stream will enter inlet 48, pass from the outside to the inside of the single filter element or cartridge 35, exit through the outlet 72, enter the twin element outlet plenum 96, pass through outlet apertures 114 into outlet tube 98, and out through both outlets 50.

It will be understood by those skilled in the purification and/or filtration art that the size of the various components may vary depending on the application, as may the various sealing mechanisms, and this is well within the scope of the present invention.

Referring now to FIGS. 8-11, there is shown a single filter assembly 30, with a multiple filter element or cartridge 116. As with the previously described single element assembly described in FIGS. 1-5, there is provided the single element housing 42 closed at the inlet end by an inlet closure member 44, having vent 44V, and at the outlet end by an outlet closure member 45. Single element inlet 48 is provided, as is single element outlet 50. Three single filter elements or cartridges 35 are provided, which, in combination with the filter frame 118, (also see FIG. 15) form the multiple filter element or cartridge 116.

However, since there are now three circular outlets 72 instead of one, it is necessary to provide the triple inlet plenum 120 having first inlet 122, second inlet 124 and third inlet 126. The rest of the triple inlet plenum 120 may be the same as the outlet plenum 80. The inlet closure member 44 may have the same perforated spacer 86, and the outlet closure member 45 may have the same arrangement for accepting the outlet tube 82. Of course, it is well within the scope of the present invention that the dimensions of these parts vary according to the particular application they are being used in. Also, it is well within the scope of the present invention that the single inlet housing may have an outlet out the side of the housing, as it is within the skill of the art to make the necessary changes given the foregoing.

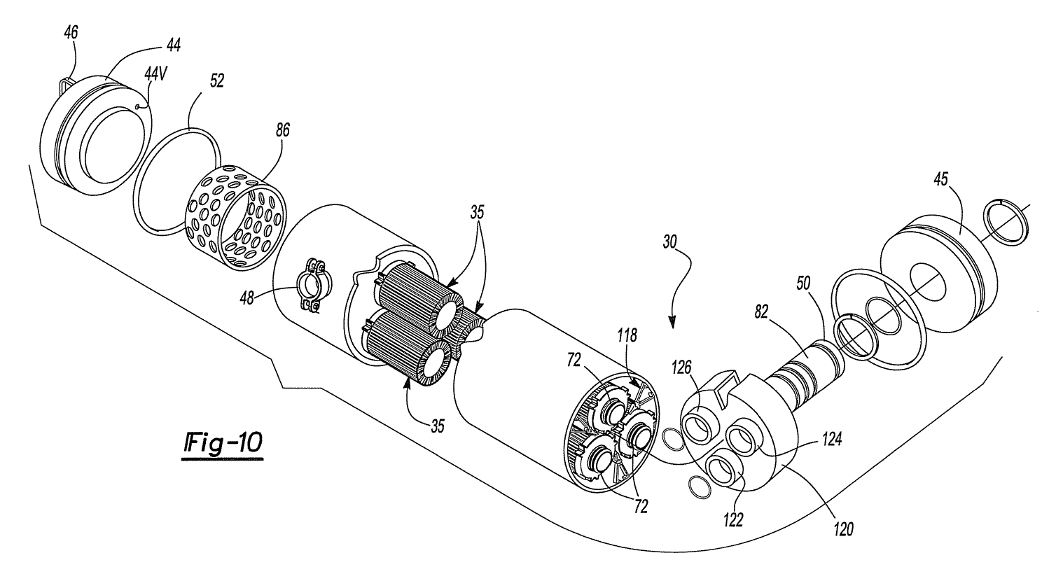

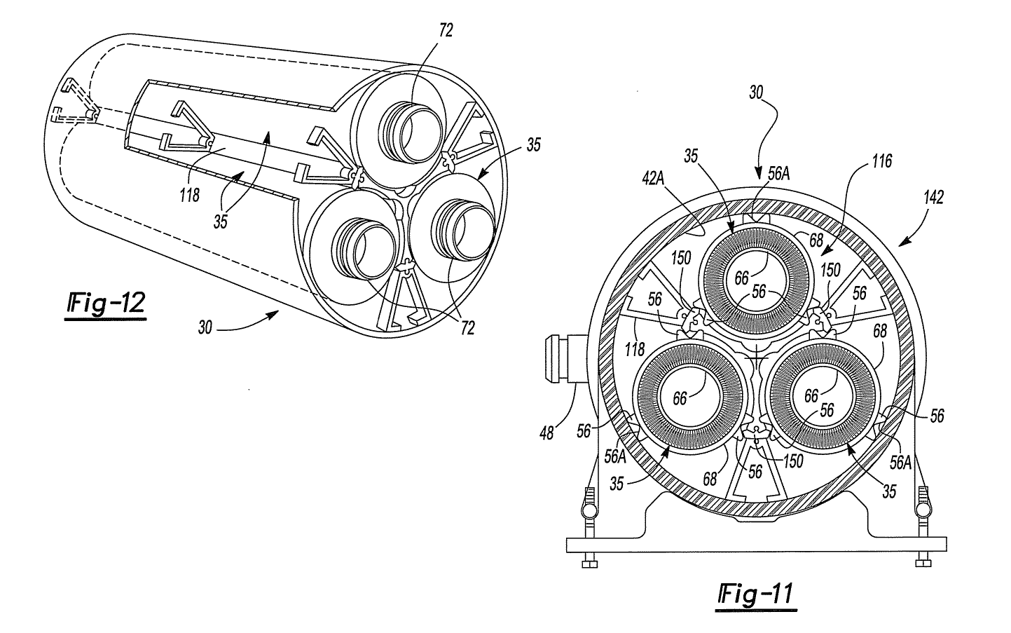

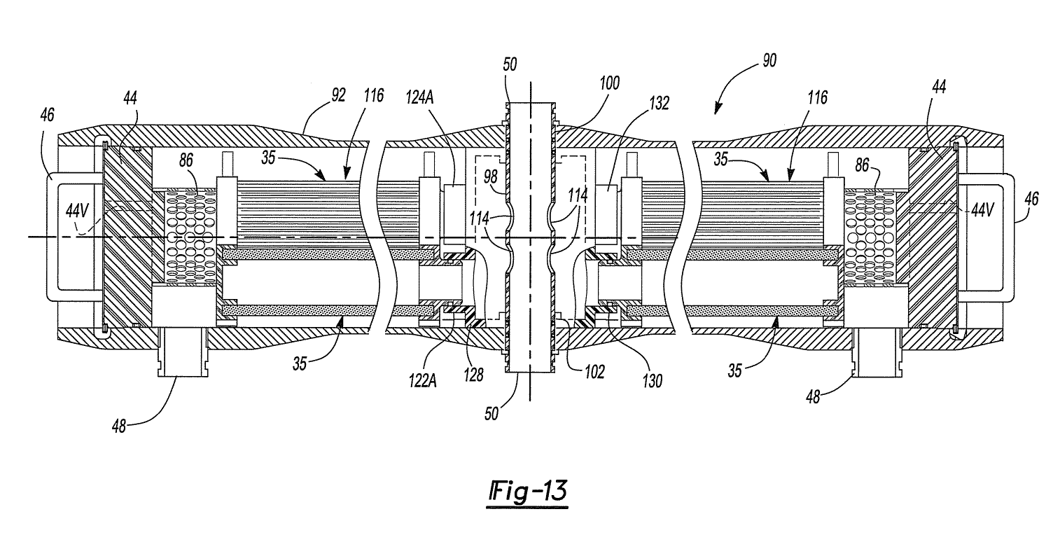

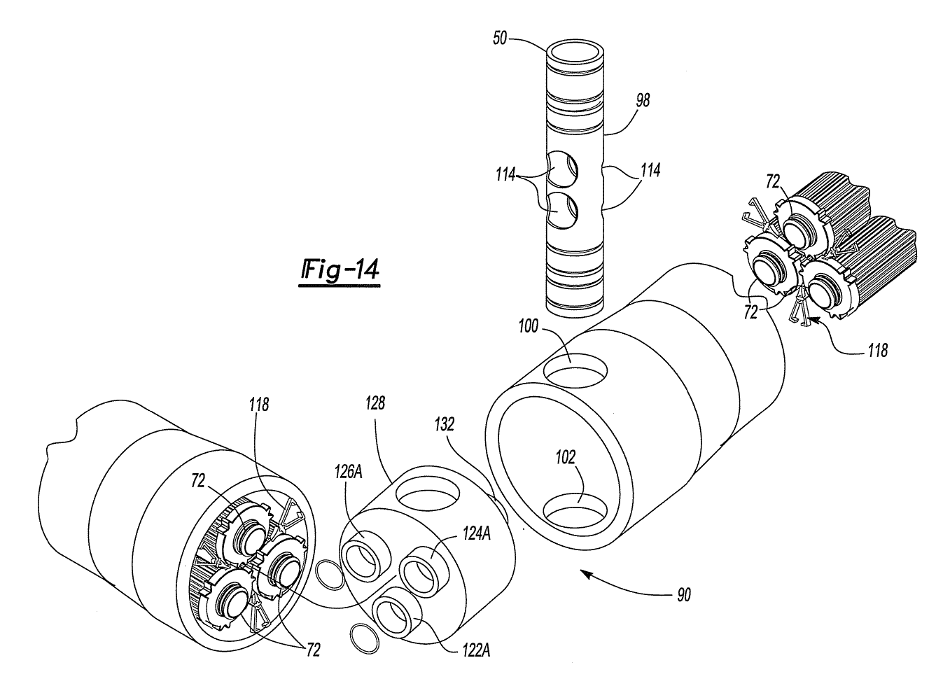

Referring to FIGS. 13 and 14, there is shown a twin filter assembly 90 containing two multiple filter elements or cartridges 116. As before, each multiple element filter or cartridge 116 preferably contains three single filter elements or cartridges 35 held in place inside the twin element housing 92 by a combination of the interior of the twin element housing 92 and a filter frame 118.

Since there are now six outlets 72 from the six single filter elements or cartridges, the outlet plenum must be a six inlet plenum, which is designated by the numeral 128 for purposes of clarity. There will be a first inlet 122A, a second inlet 124A, a third inlet 126A, a fourth inlet 130, a fifth inlet 132 and a sixth inlet 134.

The remainder of the six inlet plenum is preferably constructed in the same manner as the triple inlet plenum, with the outlet tube 82 passing through the apertures (100, 102, 102, 100) to hold the six inlet plenum 128 in place in the twin element housing 92, and with the closure members 44 (with vent 44V), and perforated spacers 86 holding the single elements or cartridges 35 in place, together with the filter frames 118. Suitable O-rings and lock washers are provided, as before.

Referring to FIG. 15, details of the filter frame, generally designated by the numeral 118, can be seen. There is illustrated a filter frame for use with three single filter elements or cartridges 35. It is well within the scope of the present invention that as few as two single filter elements 35 be used, or, more than three can be used.

Each filter frame 118 comprises one or more, preferably three, central spacer members 136. Each central spacer member 136 will have a first leg 138, a second leg 140, and a third leg 142. Each leg (138,140,142) is of a unique three part construction. A first portion 144 of each leg (138,140,142) is of equal length as measured from a central point C. Each portion 144 is radially extending toward the inner wall of the single element housing 42 or the twin element housing 92, and is spaced an equal distance from each other first portion. In the filter frame illustrated, which is to hold three single elements 35, this equal distance would be 360° (the number of degrees in a circle) divided by the number of legs (3), or 120°. The upper end 144A of first portion 144 is connected to or integral with, each other first portion 144.

The other end 144B is provided with a groove 146 which accepts a first tongue 148 formed on rail 150, which also is the second portion 153 of the first leg 138. A second tongue 152 is formed on the bottom of rail 150, and also extends axially the entire length of the rail.

The first leg is completed by the third portion 154, which is bifurcated. Third portion 154 has a top portion 156 which has a second groove 158 to accept the second tongue 152 formed on the rail. Thus, third portion 154 “snaps” on to rail 150.

Third portion 154 also has a first leg portion 159 and a second leg portion 160. First leg portion 159 terminates with a first foot portion 161, and the second leg portion 160 terminates with a second foot portion 162. First foot portion 161 and second foot portion 162 will be dimensioned to fit against the inner wall of the housing (42, 92). The second leg 140 and the third leg 142 will be constructed in the same manner to complete central spacer member 136.

A desired number of central spacer members 136 may be constructed in the same manner. The preferred number is three, but more or less central spacer members 136 may be used depending on such factors as the length of the housing (42,92) operating pressures, etc.

The filter frame 118 will keep the filter cartridges 35 properly oriented in the housing (42, 92). As shown in FIGS. 11 and 15, this is accomplished by the combination of the legs (138, 140 and 142) resting on the interior wall of the housing (42A, 92A) and the grooves 56A in two of the three tabs 56 riding on the rails 50, while the third tab 56 contacts the interior wall (42A, 92A) of the housing (42, 92). It is well within the scope of the present invention that the shape and/or number of rails 50, tabs 56 and grooves 56A can vary, depending on the application.

In turn, the filter cartridges (35) will be held in place in the housing (42, 92) by the closure members (44, 45) and perforated spacers 86.

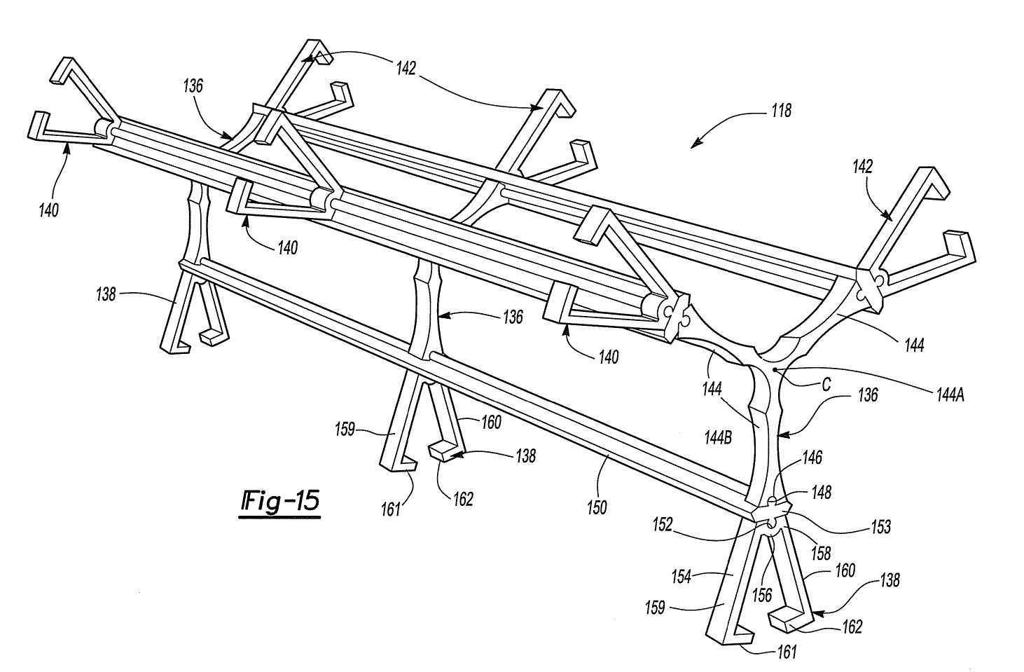

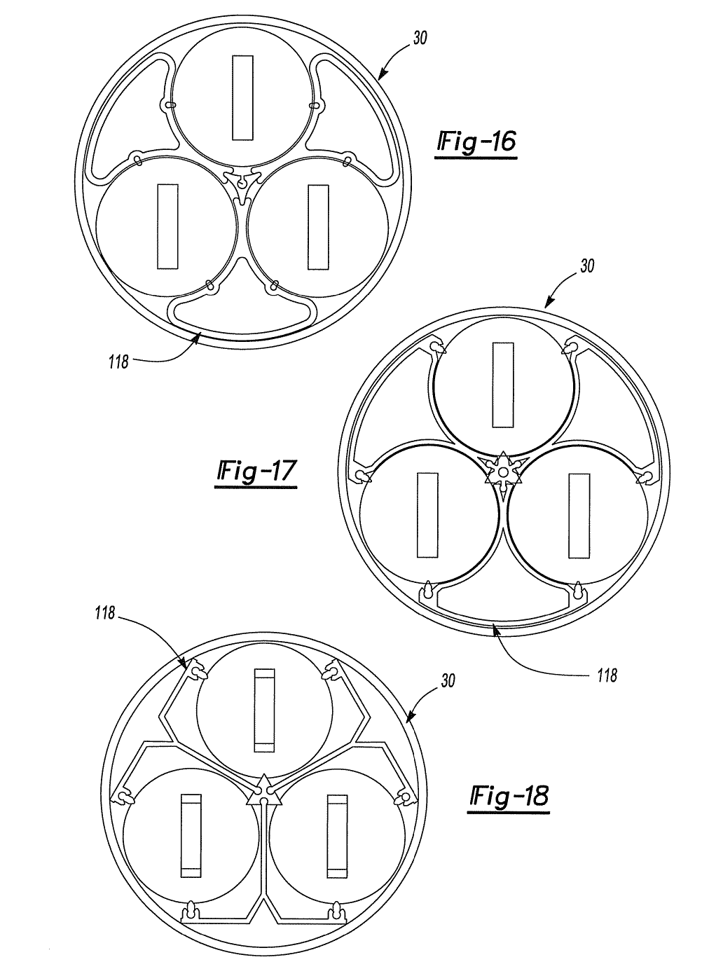

With reference to FIGS. 16-18, there are shown modifications of the filter frame 118 which may be used with the present invention. With the foregoing description, construction of the filter frames illustrated is within the capabilities of those of ordinary skill in the art.

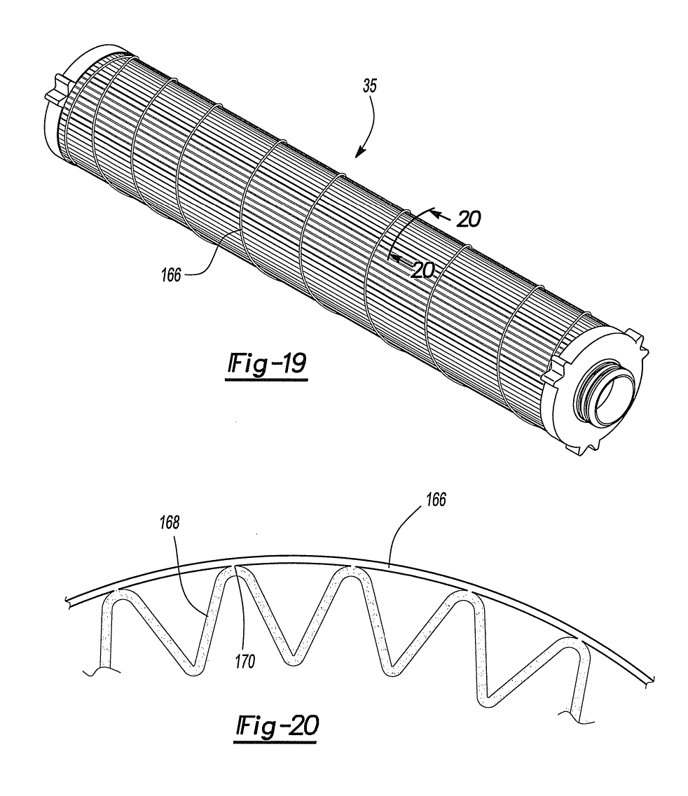

Referring now to FIGS. 19-20, there is illustrated a single filter element or cartridge 35 having a pre-impregnated tow or fiber 166 applied thereto to keep the pleats properly spaced to maintain the efficiency of the filter cartridge. The pre-impregnated tow 166 may be wound on top of itself several times near each endcap, before being helically wound around the element 35 and bound to the tips 170 of the pleats 168. Alternately, the ends of the pre-impregnated tow may be potted on with the end caps (60,62). This serves to anchor the tow at each end, as well as maintaining the pleat spacing.

The tow 166 is made up of strands of material impregnated with an adhesive. The tow 166 may be thermoset or thermoplastic impregnated. The strands can be made of materials such as, but not limited to, metal, cotton, plastic and glass. The adhesive can be made of a material such as, but not limited to, epoxies, hot melts and glues. It is preferred that the helically wound tow 166 be sonically, or otherwise, bonded to the endcaps (60, 62) to prevent its unwinding during service.

Referring to FIGS. 21 and 22, there is shown a single filter assembly having in to out flow. For ease of identification, such single filter assembly is generally designated by the numeral 30A, and the single filter element or cartridge is designated by the numeral 35A. The construction of the in-to-out single filter assembly 30A is substantially similar to the construction of the out-to-in single filter assembly 30 shown in FIG. 5, which has the preferred out to in flow, except the outlet 50 now becomes the inlet 48A, and the inlet 48 now becomes the outlet 50A. In addition, the inlet end cap 60 becomes the outlet end cap 62A, and the outlet end cap 62 becomes the inlet end cap 60A. Also, outlet plenum 80 is now inlet plenum 80A, and outlet tube 82 is now inlet tube 82A. Inlet closure member 44 is now labeled as outlet closure member 44A, and outlet closure member is now labeled as inlet closure member 45A. Since the flow is reversed, if needed, additional support to prevent rupture of the porous media 58 will be need at the outside of the in-to-out single filter element or cartridge. To accomplish this, an outer, support core 88A, having perforations 89A may be provided.

Aside from the change in nomenclature, there is virtually no difference in construction between the single filter assembly 30 with out to in flow, and the single filter assembly 30A with in to out flow. This allows the same housing to be used interchangeably for in to out and out to in flow with a simple change of filter element or cartridge.

The in to out flow single filter element or cartridge 35A may be made identical in size to the out to in flow single filter element or cartridge 35 so as to be directly interchangeable any time it is desired to change the flow direction, or it may be made in any desired size. Since the multiple filter element or cartridge 116 includes at least two, and preferably three, of the single elements or cartridges 35, the flow direction through a multiple filter element or cartridge 116 can easily be changed.

FIG. 22 shows how an outer, perforated, support core 88A may be slipped over the porous media 58.

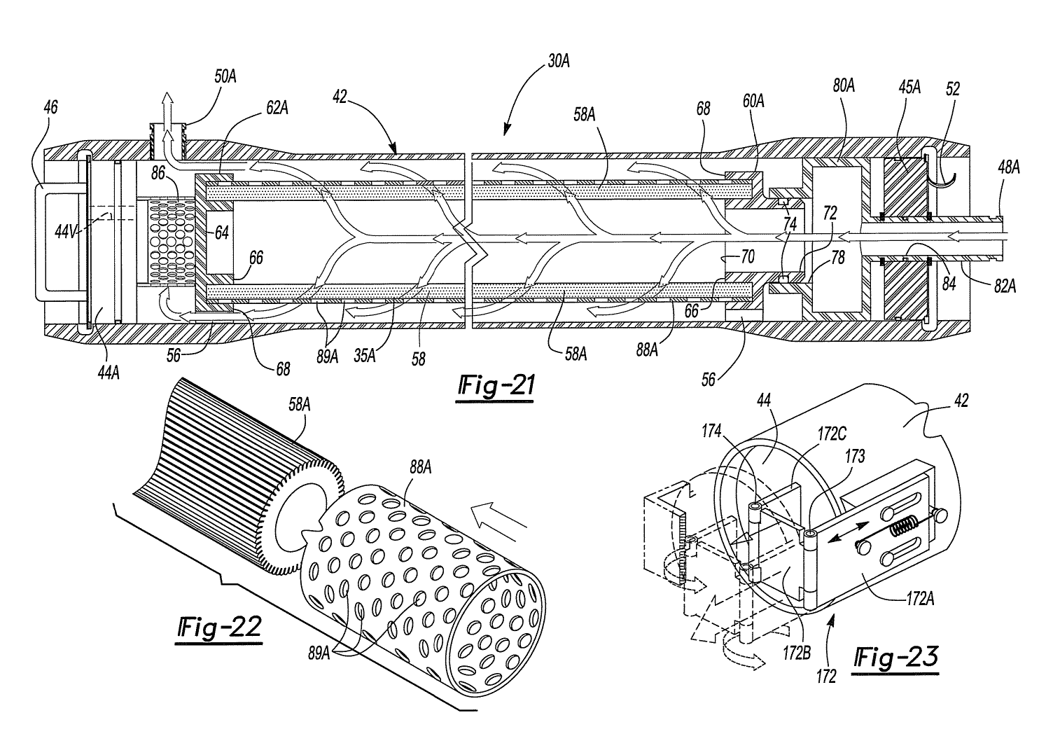

Referring now to FIG. 23, for convenient changing of either a single element filter or cartridge 36, or a multiple filter element or cartridge 116, whether in a single filter assembly 30, or in a twin filter assembly 90, the inlet closure member 44, or the outlet closure member 45, instead of having a handle 46, may have a davit assembly 172 mounted thereto. The davit assembly comprises a spring loaded slidable member 172A, a first hinge member 172B, and a second hinge member 172C. First hinge member 172B is rotatably mounted to spring-loaded slidable member 172A by first hinge pin 173. In turn, second hinge member 172C is rotatably mounted to first hinge member 172B by second hinge pin 174.

When it is desired to change a filter cartridge, the spiral retaining ring 52 is removed, and the closure member 44 is pulled outward along the axis of the housing 42, which causes like movement of the slideable hinge member 172A, until the closure member 44 clears the housing 42. Once this occurs, the closure member 44 can be swung open and the filter element or cartridge (35,116) can be removed for inspection or replacement.

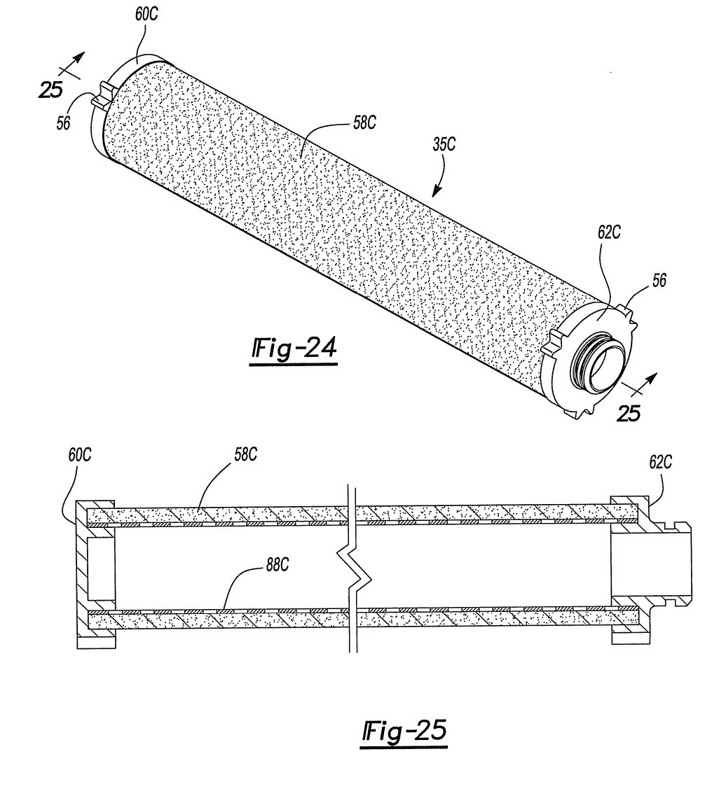

With reference to FIGS. 24 and 25, a modification of the present invention is shown having a carbon media. An out to in version is shown, although an in to out version is well within the scope of the present invention.

The single filter element or cartridge, now designated 35C for purposes of clarity, has an inlet end cap 60C, which may be identical to inlet end cap 60 shown in FIG. 5, and an outlet end cap 62C, which may be identical to outlet end cap 62 shown in FIG. 5. These are fixed to the ends of a carbon media 58C, and an inner, perforated support core 88C is provided if desired.

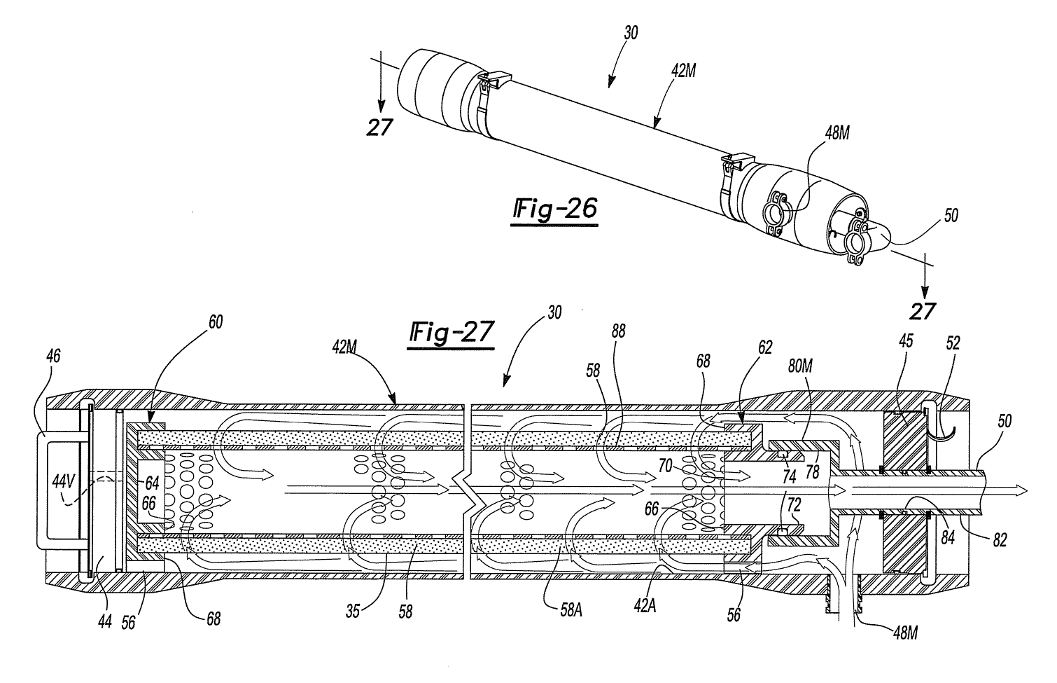

With reference to FIGS. 26 & 27, there is shown a modification of the invention which is useful when it is desirable to have the inlet 48 and the outlet 50 proximate the same end of the filter assembly (30,90). A single filter assembly 30 having the inlet 48M and the outlet 50 proximate the same end of the modified single element housing 42M. Although a single filter assembly 30 is illustrated, such a construction of a twin filter assembly 90 is well within the skill of the art, and need not be described in detail herein.

With reference to FIG. 5, the only substantial difference between the single element housing 42 of FIG. 5, and the modified single element housing 42M of FIG. 27 is the reduction of the diameter of the outlet plenum 80 of FIG. 5 to the smaller diameter of the modified outlet plenum 80M shown in FIG. 27. This permits fluid entering the relocated inlet 48, now designated 48M for clarity, to enter the inlet 48M, pass around the outlet plenum 80M, and travel in the space between the inner wall 42A of the modified single element housing 42M and the single filter element 35. Once this flow occurs, the operation of the single filter assembly is the same as for the construction shown in FIG. 5. The adaptation of this construction to a twin filter assembly 90 is easily done by one skilled in the art.

What is claimed:

1. A filter assembly comprising:
a hollow, axially extending, generally tubular-shaped, metal and/or polymer housing;
a first closure member closing one end of the metal and/or polymer housing;
a second closure member closing the other end of the metal and/or polymer housing, thereby forming an enclosed space to receive a filter element or cartridge;
an inlet provided proximate either the first closure member or the second closure member and in fluid communication with the enclosed space;
an outlet provided proximate the other of the first closure member or the second closure member and in fluid communication with the enclosed space, thereby providing a fluid flow path through the metal and/or polymer housing; and
at least one externally centering filter element having a porous media sealingly interposed in the enclosed space in a manner such that the flow through the enclosed space must flow through the porous media.

2. A single filter assembly comprising:
a hollow, axially extending, generally tubular-shaped, metal and/or polymer housing;
a first closure member closing one end of the metal and/or polymer housing;
a second closure member closing the other end of the metal and/or polymer housing, thereby forming an enclosed space to receive an externally centering filter element or cartridge;
an inlet provided proximate either the first closure member or the second closure member and in fluid communication with the enclosed space;
an outlet provided proximate the other of the first closure member or the second closure member and in fluid communication with the enclosed space, thereby providing a fluid flow path through the metal and/or polymer housing.

3. The single filter assembly defined in claim 2, further comprising:
at least one externally centering filter element having a porous media sealingly interposed in the enclosed space in a manner such that the flow through the enclosed space must flow through the porous media.

4. The single filter assembly defined in claim 3, wherein the externally centering filter element is a single filter element or cartridge.

5. The single filter assembly defined in claim 4, wherein the single filter element or cartridge comprises:
a) a first or inlet endcap having a plurality of tabs spaced about its periphery;
b) a second or outlet endcap having a plurality of tabs spaced about its periphery and a circular outlet aperture; and
c) a porous media having the first or inlet endcap fixed on one end of the porous media, and the second, or outlet endcap potted on the other end of the porous media.

6. The single filter assembly defined in claim 3, wherein the externally centering filter element is a multiple filter element or cartridge.

7. The single filter assembly defined in claim 6, wherein the multiple filter element or cartridge comprises:
a) a filter frame;
b) a plurality of single filter elements or cartridges mounted in the filter frame, each of the plurality of single filter elements or cartridges comprising;
i) a first or inlet endcap having a plurality of tabs spaced about its periphery;
ii) a second or outlet endcap having a plurality of tabs spaced about its periphery and a circular outlet aperture; and
iii) a porous media having the first or inlet endcap fixed on one end of the porous media, and the second, or outlet endcap fixed on the other end of the porous media.

8. A single filter assembly comprising:
a) a hollow, axially extending, generally tubular-shaped, metal and/or polymer housing having a substantially uniform inside diameter, said housing further comprising:
i) a retaining groove provided in the metal and/or polymer housing proximate each end thereof;
ii) an inlet provided proximate one end of the metal and/or polymer housing;
b) an inlet closure member inserted in the end of the metal and/or polymer housing proximate the inlet, the inlet closure member including:
i) a body portion;
ii) a handle mounted to one side of the body portion; and
iii) a perforated spacer in contact with the other side of the body portion.
c) an outlet closure member inserted in the other end of the metal and/or polymer housing, the outlet closure member having an outlet aperture to receive an outlet tube of an outlet plenum;
d) an outlet plenum upstream of the outlet closure member having a plenum inlet and an outlet tube, the outlet tube sealingly mounted in the outlet aperture of the outlet closure member thereby forming an enclosed space between the inlet closure member and the outlet plenum inlet to provide a fluid flow path through the metal and/or polymer housing from the inlet thereof to the outlet tube.

9. The single filter assembly defined in claim 8, including an externally centering filter element or cartridge having a porous media interposed in the enclosed space in a manner such that the flow through the enclosed space must flow through the porous media in the filter element or cartridge.

10. The single filter assembly defined in claim 9, wherein the externally centering filter element or cartridge is a single filter element or cartridge.

11. The single filter assembly defined in claim 9, wherein the externally centering filter element or cartridge is a multiple filter element or cartridge.

12. The single filter assembly defined in claim 10, wherein each single filter element or cartridge comprises:
a) a first or inlet endcap having a plurality of tabs spaced about its periphery;
b) a second or outlet endcap having a plurality of tabs spaced about its periphery and a circular outlet aperture; and
c) a porous media having the first or inlet endcap fixed on one end of the porous media, and the second, or outlet endcap fixed on the other end of the porous media.

13. The single filter assembly defined in claim 11, wherein each multiple filter element or cartridge comprises:
a) a filter frame;
b) a plurality of single filter elements or cartridges mounted in the filter frame, each of the plurality of single filter elements or cartridges comprising;
i) a first or inlet endcap having a plurality of tabs spaced about its periphery;
ii) a second or outlet endcap having a plurality of tabs spaced about its periphery and a circular outlet aperture; and
iii) a porous media having the first or inlet endcap fixed on one end of the porous media, and the second, or outlet endcap fixed on the other end of the porous media.

14. A twin filter assembly comprising:
a hollow, axially extending, generally tubular-shaped, metal and/or polymer housing;
a first inlet closure member closing one end of the metal and/or polymer housing;
a second inlet closure member closing the other end of the metal and/or polymer housing;
an outlet plenum sealingly provided between the inlet closure members to provide a pair of enclosed spaces, each of the pair of enclosed spaces receiving a filter element or cartridge, the outlet plenum in fluid communication with atmosphere and each of the pair of enclosed spaces;
a first inlet provided proximate the first inlet closure member and in fluid communication with one of the pair of enclosed spaces; and
a second inlet provided proximate the second inlet closure member and in fluid communication with the other of the pair of enclosed spaces, thereby providing a pair of fluid paths from the inlet, through the enclosed spaces and out the outlet plenum.

15. The twin filter assembly defined in claim 14, further comprising:
a pair of externally centering filter elements or cartridges, each having a porous media, one of said pair of filter elements or cartridges interposed in each of the pair of enclosed spaces in a manner such that the flow through each of the enclosed spaces must flow through the porous media in one of said pair of filter elements or cartridges.

16. The twin filter assembly defined in claim 15, wherein at least one of the pair of externally centering filter elements or cartridges is a single filter element or cartridge comprising;
a) a first or inlet endcap having a plurality of tabs spaced about its periphery;
b) a second or outlet endcap having a plurality of tabs spaced about its periphery and a circular outlet aperture; and
c) a porous media having the first or inlet endcap fixed on one end of the porous media, and the second, or outlet endcap fixed on the other end of the porous porous media.

17. The twin filter assembly defined in claim 15, wherein at least one of the pair of externally centering filter elements or cartridges is a multiple filter element or cartridge comprising:
a) a filter frame;
b) a plurality of single filter elements or cartridges mounted in the filter frame, each of the plurality of single filter elements or cartridges comprising;
i) a first or inlet endcap having a plurality of tabs spaced about its periphery;
ii) a second or outlet endcap having a plurality of tabs spaced about its periphery and a circular outlet aperture; and
iii) a porous media having the first or inlet endcap fixed on one end of the porous media, and the second, or outlet endcap fixed on the other end of the porous media.

18. The twin filter assembly defined in claim 16, wherein each single filter element or cartridge comprises:
a first or inlet endcap having a plurality of tabs spaced about its periphery;
a second or outlet endcap having a plurality of tabs spaced about its periphery and a circular outlet aperture; and
a porous media having the first or inlet endcap fixed on one end of the porous media, and the second, or outlet endcap fixed on the other end of the porous media.

19. The twin filter assembly defined in claim 17, wherein each multiple filter element or cartridge comprises at least two single filter elements or cartridges.

20. A twin filter assembly comprising:
a) a hollow, axially extending, generally tubular-shaped, metal and/or polymer housing having a substantially uniform diameter, said housing further comprising:
i) at least one housing outlet aperture proximate the midpoint of the metal and/or polymer housing;
ii) a retaining groove provided in said metal and/or polymer housing proximate each end thereof;
iii) an inlet provided proximate each end of the metal and/or polymer housing;
b) a twin element plenum in fluid communication with the at least one housing outlet aperture, said outlet plenum further comprising:
i) a hollow body portion having a pair of axially aligned outlet apertures coaxial with the at least one housing aperture;
ii) a first inlet coaxial with the axis of the metal and/or polymer housing and in fluid communication with the hollow body portion of the outlet plenum;
iii) a second inlet coaxial with the axis of the fiber reinforced plastic housing and in fluid communication with the hollow body portion of the outlet plenum; and
iv) an outlet tube passing through the at least one housing aperture and the pair of axially aligned outlet apertures.

21. The twin filter assembly defined in claim 20, further comprising:
a) an inlet closure member inserted in each end of the fiber reinforced plastic housing, each inlet closure member including;
i) a body portion;
ii) a handle mounted to one side of the body portion, and
iii) a perforated spacer in contact with the other side of the body portion.

22. The twin filter assembly defined in claim 21, further comprising:
a retaining spiral ring inserted in each of the retaining grooves to hold the inlet closure members in place.

23. The twin filter assembly defined in claim 22, further comprising:
a first externally centering filtration element or cartridge interposed between the perforated spacer of an inlet closure member and the first inlet of the twin element plenum.

24. The twin filter assembly defined in claim 23, further comprising:
a second externally centering filtration element or cartridge interposed between the perforated spacer of an inlet closure member and the first inlet of the twin element plenum.

25. The twin filter assembly defined in claim 24, wherein the externally centering filtration element or cartridge is a multiple filtration element or cartridge.

26. The twin filter assembly defined in claim 25, wherein the externally centering filtration element or cartridge is a single filtration element or cartridge.

27. The twin filter assembly defined in claim 26, wherein the externally centering single filtration element or cartridge comprises:
a) a first or inlet endcap having a plurality of tabs spaced about its periphery;
b) a second or outlet endcap having a plurality of tabs spaced about its periphery and a circular outlet aperture; and
c) a porous media having the first or inlet endcap fixed on one end of the porous media, and the second, or outlet endcap fixed on the other end of the porous media.

28. The twin filter assembly defined in claim 25, wherein the multiple filtration element or cartridge comprises:
a) a filter frame; and
b) a plurality of single filter elements or cartridges held in a spaced, fixed relationship by the filter frame when the multiple filter element or cartridge is inserted into the metal and/or polymer housing and the filter frame cooperates with the interior wall of the metal and/or polymer housing.

29. The single filter assembly defined in claim 2 and having in to out flow.

30. The single filter assembly defined in claim 2 having out to in flow.

31. The twin filter assembly defined in claim 14 having in to out flow.

32. The twin filter assembly defined in claim 14 having out to in flow.

33. The single filter assembly defined in claim 2 and having at least the first closure member hingedly mounted to the hollow, axially extending, generally tubular shaped housing by a davit assembly

34. The twin filter assembly defined in claim 14 and having at least the first closure member hingedly mounted to the hollow, axially extending, generally tubular shaped housing by a davit assembly.

35. A single filter element or cartridge comprising:
a) a first or inlet endcap having a plurality of radially extending tabs equally spaced about its periphery;
b) a second or outlet endcap having a plurality of radially extending tabs spaced equally about its periphery and a circular outlet aperture; and
c) a filter media having the first or inlet endcap on one end of the porous media, and the second, or outlet endcap fixed on the other end of the porous media; and
d) a preimpregnated tow wound around the porous media to aid in maintaining the porous media.

36. A single filter element or cartridge for in to out flow comprising:
a) a first or inlet endcap having a plurality of radially extending tabs equally spaced about its periphery;
b) a second or outlet endcap having a plurality of radially extending tabs spaced equally about its periphery and a circular outlet aperture;
c) an internal core having perforations interposed between the first or inlet endcap and the second or outlet endcap and in fluid communication with the circular outlet aperture,
d) a porous media surrounding the internal core,
e) a preimpregnated tow wound around the porous media.

37. A filter frame comprising;
a) a plurality of central spacer members, each of the central spacer members having a plurality of leg portions, each of the plurality of leg portions configured to receive a rail; and
b) an equal plurality of rails connected to the plurality of leg members to hold the leg members in a spaced, fixed relationship.

38. A twin filter assembly comprising:
a hollow, axially extending, generally tubular-shaped, metal and/or polymer housing;
a first closure member closing one end of the metal and/or polymer housing;
a second closure member closing the other end of the metal and/or polymer housing,
an outlet device interposed in the hollow, axially extending, generally tubular-shaped, metal and/or polymer housing proximate the middle thereof, thereby forming a pair of enclosed spaces to receive a filter element or cartridge, the outlet device being in fluid communication with each of the pair of enclosed spaces;
an inlet provided proximate both the first closure member and the second closure member and in fluid communication with the enclosed space; thereby providing a fluid flow path through the metal and/or polymer housing; and
at least one filter element having a porous media sealingly interposed in each of the enclosed spaces in a manner such that the flow through the enclosed space must flow through the porous media.

39. An externally centering filter element or cartridge comprising:
a) a first or inlet endcap having a plurality of tabs spaced about its periphery;
b) a second or outlet endcap having a plurality of tabs spaced about its periphery and a circular outlet aperture; and
c) a porous media having the first or inlet endcap fixed on one end of the porous media, and the second, or outlet endcap fixed on the other end of the porous media.

40. An externally centering filter element or cartridge comprising:
a) a first or inlet endcap having a plurality of tabs spaced about its periphery;
b) a second or outlet endcap having a plurality of tabs spaced about its periphery and a circular outlet aperture; and
c) a fibrous porous media having the first or inlet endcap fixed on one end of the fibrous porous media, and the second, or outlet endcap fixed on the other end of the fibrous porous media.

41. A single filter element or cartridge comprising:
a) a first or inlet endcap having a plurality of tabs spaced about its periphery;
b) a second or outlet endcap having a plurality of tabs spaced about its periphery and a circular outlet aperture; and
c) an adsorbent media having the first or inlet endcap fixed on one end of the adsorbent media, and the second, or outlet endcap fixed on the other end of the adsorbent media.

42. The single filter element or cartridge defined in claim 41, wherein the adsorbent media is carbon.

43. A single filter element or cartridge comprising:
a) a first endcap having a plurality of tabs spaced about its periphery;
b) a second, smaller endcap having a plurality of tabs spaced about its periphery and a circular outlet aperture; and
c) a tapered porous media having the first endcap fixed on one end of the porous media, and the second endcap fixed on the other end of the porous media.

44. The single filter element or cartridge defined in claim 43, wherein the tapered porous media is an adsorbent media.

45. The single filter element or cartridge defined in claim 43, wherein the tapered porous media is a carbon media.

46. The single filter element or cartridge defined in claim 43, wherein the tapered porous media is a fibrous porous media.

47. A filter assembly comprising:
a hollow, axially extending, tapered, metal and/or polymer housing;
a first closure member closing one end of the metal and/or polymer housing;
a second closure member closing the other end of the metal and/or polymer housing, thereby forming an enclosed space to receive a filter element or cartridge;
an inlet provided proximate either the first closure member or the second closure member and in fluid communication with the enclosed space;
an outlet provided proximate the other of the first closure member or the second closure member and in fluid communication with the enclosed space, thereby providing a fluid flow path through the metal and/or polymer housing; and
at least one externally centering filter element or cartridge having a tapered porous media sealingly interposed in the enclosed space in a manner such that the flow through the enclosed space must flow through the porous media.

48. The filter assembly defined in claim 1, wherein a vent is provided in the first closure member, the second closure member, or in the housing.

49. The filter assembly defined in claim 2, wherein a vent is provided in the first closure member, the second closure member, or in the housing.

50. The filter assembly defined in claim 8, wherein a vent is provided in the inlet closure member, the outlet closure member, or in the housing.

51. The filter assembly defined in claim 14, wherein a vent is provided in the first inlet closure member and the second inlet closure member, or in the housing.

52. The filter assembly defined in claim 1, wherein the inlet and outlet are proximate the same end of the housing.

53. The single filter assembly defined in claim 2, wherein the inlet and outlet are proximate the same end of the housing.

54. The single filter assembly defined in claim 8, wherein the inlet and outlet are proximate the same end of the metal and/or polymer housing.

55. The twin filter assembly defined in claim 14, wherein the first inlet and the second inlet are proximate the outlet.

56. The twin filter assembly defined in claim 38, wherein the inlet provided proximate both the first closure member and the second closure member is now provided proximate the outlet device.
